(19) United States
(12) Patent Application Publication
(10) Pub. No.: US 2013/0237419 A1
(43) Pub. Date: Sep. 12, 2013

(54) ORGANIC COLLOID-STABILIZED EMULSION FOR CONTROLLING PESTICIDE SPRAY DRIFT

(71) Applicants: Hui Shao, Carmel, IN (US); Hong Zhang, Carmel, IN (US); Holger Tank, Zionsville, IN (US); Mei Li, Westfield, IN (US); Kuide Qin, Westfield, IN (US); Lei Liu, Carmel, IN (US); Stephen L. Wilson, Zionsville, IN (US)

(72) Inventors: Hui Shao, Carmel, IN (US); Hong Zhang, Carmel, IN (US); Holger Tank, Zionsville, IN (US); Mei Li, Westfield, IN (US); Kuide Qin, Westfield, IN (US); Lei Liu, Carmel, IN (US); Stephen L. Wilson, Zionsville, IN (US)

(73) Assignee: Dow AgroSciences LLC, Indianapolis, IN (US)

(21) Appl. No.: 13/780,415

(22) Filed: Feb. 28, 2013

Related U.S. Application Data
(60) Provisional application No. 61/608,141, filed on Mar. 8, 2012.

(51) Int. Cl. A01N 25/04

(52) U.S. Cl. CPC A01N 25/04
USPC 504/127; 504/363; 504/361; 504/345

(57) ABSTRACT

Spray drift during the application of an aqueous mixture of an auxinic herbicide is reduced by incorporating into a spray mixture an organic colloid-stabilized oil-in-water emulsion.

This application claims the benefit of U.S. Provisional Patent Application Ser. No. 61/608,141, filed Mar. 8, 2012.

### BACKGROUND

Agricultural spraying by economical and available technologies uses hydraulic spray nozzles that inherently produce a wide spectrum of spray droplet sizes. The potential for these spray droplets to drift from the initial, desired site of application is found to be a function of droplet size, with smaller droplets having a higher propensity for off-target movement. Significant research efforts, involving numerous field trials, wind tunnel tests and subsequent generation of predictive math models have led to a greatly enhanced understanding of the relationship between spray droplet size and potential for off-target drift. Although other factors such as meteorological conditions and spray boom height contribute to the potential for drift, spray droplet size distribution has been found to be a predominant factor. Teske et. al. (Teske M. E., Hewitt A. J., Valcore, D. L. 2004. The Role of Small Droplets in Classifying Drop Size Distributions ILASS Americas 17^{th} Annual Conference: Arlington Va.) have reported a value of <156 microns (μm) as the fraction of the spray droplet distribution that contributes to drift. Robert Wolf (Wolf, R. E., Minimizing Spray Drift, Dec. 15, 1997, Microsoft® PowerPoint Presentation, available at www.bae.ksu.edu/faculty/wolf/drift.htm, last viewed Jan. 26, 2012) cites a value of <200 μm as the driftable fraction. A good estimation of droplet size likely to contribute to drift, therefore, is the fraction below about 150 μm.

The negative consequences of off-target movement can be quite pronounced. Some herbicides have demonstrated very sensitive phytotoxicity to particular plant species at extremely low parts per million (ppm) or even parts per billion (ppb) levels, resulting in restricted applications around sensitive crops, orchards, and residential plantings. For example, the California Dept of Pesticide Regulation imposes buffers of ½-2 miles for propanil containing herbicides applied aerially in the San Joaquin valley.

### SUMMARY

Spray drift during aqueous pesticide application can be reduced by incorporating an organic colloid-stabilized oil-in-water emulsion into an aqueous pesticidal spray mixture. Methods and compositions to reduce spray drift during the application of an aqueous pesticidal spray mixture are described herein. The methods to reduce spray drift during the application of an aqueous pesticidal spray mixture containing a pesticide include incorporating into the aqueous pesticidal spray mixture from 0.01 to 10 weight percent of an organic colloid-stabilized oil-in-water emulsion.

Additionally, aqueous concentrate compositions are described that include from about 0.1 to about 95 weight percent of a water soluble salt of at least one pesticide and from about 0.01 to about 20 weight percent of an organic colloid-stabilized oil-in-water emulsion.

### DETAILED DESCRIPTION

Methods and compositions to reduce spray drift are described herein. The methods and compositions reduce the amount of driftable fines of a pesticide spray in both aerial and ground spray applications. The methods include the use of aqueous pesticidal spray mixtures incorporating organic colloid-stabilized oil-in-water emulsions and one or more pesticides. As used herein the term organic colloid refers to an organic material dispersed as solid microscopic particles in a continuous water phase. Such organic particles may comprise synthetic polymers, latexes, natural waxes, paraffinic waxes, and the like, and may have an average particle size that ranges from 0.001 micron (μm) to 1000 μm. The term latex as used herein refers to a dispersion of synthetic polymer particles in water that are formed by polymerizing a monomer or a mixture of monomers such as, for example, styrene that has been emulsified with surfactants. The aqueous pesticidal spray mixtures described herein can include herbicides, insecticides, or fungicides. Herbicides useful with the methods and compositions described herein include auxinic herbicides such as, for example, clopyralid, triclopyr, 2,4-D, 2,4-DB, MCPA, MCPB, dicamba, aminopyralid, picloram, or mixtures thereof. The methods described herein are most particularly useful for the application of herbicides that are subject to restricted applications around sensitive crops such as spray mixtures containing glyphosate, 2,4-D, triclopyr, dicamba, or mixtures thereof.

The organic colloid-stabilized oil-in-water emulsions useful with the methods and compositions described herein may be prepared from a water-insoluble oil, an organic colloid, and water. As used herein, water-insoluble oil refers to an oil that is immiscible with water and has a very low solubility in water, typically less than 2000 parts per million (ppm). The oil can be, for example, paraffinic oil, aliphatic oil, aromatic oil, vegetable oil, seed oil or animal oil, or monoesters derived from vegetable, seed or animal oils, or mixtures thereof. Organic colloids suitable for use with the methods and composition described herein include polymer, co-polymer and wax dispersions, and latexes. The organic colloid may be a cationic organic colloid, an anionic organic colloid, or a nonionic organic colloid. Polymer, co-polymer, and wax dispersions suitable as organic colloids for use with the methods and compositions described herein include, for example, polyethylene dispersions, ethylene-acrylic acid copolymer dispersions, paraffin wax dispersions, carnauba wax dispersions, and mixtures thereof. Latexes suitable as organic colloids for use with the methods and compositions described herein include synthetic polymer and copolymer latexes prepared from monomers or mixtures of monomers such as, for example, styrene, methyl methacrylate and other methacrylate esters, vinyl acetate, butadiene, acrylate esters such as ethyl acrylate, butyl actylate and 2-ethylhexyl acrylate, acrylonitrile, vinyl chloride, vinylidene chloride, acrylic acid, methacrylic acid, and itaconic acid.

As used herein an organic colloid-stabilized oil-in-water emulsion refers to a 2-phase, homogeneous liquid mixture formed by mixing together two immiscible liquids, a water-insoluble oil and water, in the presence of an organic colloid. A smaller volume of the oil is typically dispersed as tiny droplets (i.e., the dispersed phase) in a larger volume of the water (i.e., the continuous phase) with a suitable amount of mixing energy and in the presence of the organic colloid to form the organic colloid-stabilized oil-in-water emulsion commonly known as a Pickering emulsion. The organic colloid serves to stabilize or inhibit conversion of the oil-in-water emulsion back into the two immiscible liquids from which it was formed. Pickering emulsions may in some instances offer improved stability over surfactant stabilized oil-in-water emulsions.

The organic colloid-stabilized oil-in-water emulsion can be incorporated into the aqueous pesticidal spray mixture, for example, by being tank-mixed directly with the diluted pesticidal formulation. The organic colloid-stabilized oil-in-water emulsion may be incorporated into the aqueous pesticidal spray mixture at a concentration from 0.01 to 10 weight percent of the final spray mixture. Additional examples of concentrations for the organic colloid-stabilized oil-in-water emulsion incorporated into the aqueous pesticidal spray mixture include, from 0.01 to 9 weight percent of the final spray mixture, from 0.01 to 8 weight percent of the final spray mixture, from 0.01 to 7 weight percent of the final spray mixture, from 0.01 to 6 weight percent of the final spray mixture, from 0.01 to 5 weight percent of the final spray mixture, from 0.01 to 4.5 weight percent of the final spray mixture, from 0.01 to 4 weight percent of the final spray mixture, from 0.01 to 3.5 weight percent of the final spray mixture, from 0.01 to 3 weight percent of the final spray mixture, from 0.01 to 2.5 weight percent of the final spray mixture, from 0.01 to 2 weight percent of the final spray mixture, from 0.01 to 1.5 weight percent of the final spray mixture, and from 0.05 to about 1 weight percent of the final spray mixture.

The aqueous pesticidal spray mixtures disclosed herein may include insecticides, herbicides, herbicide safeners, or fungicides and the aqueous pesticidal spray mixtures may be applied for the control of unwanted plants, fungi, or insects at levels dependent on the concentration of the active ingredient needed to control the target pest.

The aqueous pesticidal spray mixtures as described herein may be applied in conjunction with one or more other active ingredients to control a wider variety of unwanted plants, fungi, or insects. When used in conjunction with the other active ingredients, the presently claimed compositions can be formulated with the other active ingredient or active ingredients as premix concentrates, tank mixed with the other active ingredient or active ingredients for spray application, or applied sequentially with the other active ingredient or active ingredients in separate spray applications.

An example of a composition as described herein that may be used in conjunction with another active ingredient comprises an aqueous pre-mix concentrate containing a mixture of glyphosate and an auxinic herbicide such as a water soluble salt of 2,4-D, a water soluble salt of triclopyr, a water soluble salt of dicamba, or mixtures thereof. Such aqueous pre-mix herbicidal concentrates may be diluted from 1 to 2000 fold in water at the point of use depending on the agricultural practices and used in pre-emergent and post-emergent spray applications to control weeds in crops.

In some situations, the aqueous pesticidal spray mixtures may contain one or more biocides. Biocides may be present in the composition from about 0.001 wt % to about 0.1 wt %. For further example, the one or more biocides may be present in the composition at 0.001 wt % to 0.1 wt %, 0.005 wt % to 0.1 wt %, 0.01 wt % to 0.1 wt %, 0.02 wt % to 0.1 wt %, 0.03 wt % to 0.1 wt %, 0.04 wt % to 0.1 wt %, 0.05 wt % to 0.1 wt %, 0.06 wt % to 0.1 wt %, 0.07 wt % to 0.1 wt %, 0.08 wt % to 0.1 wt %, or 0.09 wt % to 0.1 wt %. Examples of biocides include, but are not limited to, bactericides, viricides, fungicides, parasiticides, and the like. Examples of biocide active ingredients include, but are not limited to, phenol compounds (such as phenol, thymol, pentachlorophenol, cresol, and p-chloro-m-xylenol), aldehydic compounds (such as formaldehyde, glutaraldehyde, and paraformaldehyde), acid compounds (such as benzoic acid, sorbic acid, mucochloric acid, and mucobromic acid), esters of p-hydroxybenzoic acid (such as methyl-p-hydroxybenzoate and butyl-p-hydroxybenzoate), rare earth salts, amines, disulfides, heterocyclic compounds (such as thiazinium salts, thiazolinones, and benzimidazoles), quaternary ammonium salts, organic mercury compounds, hexamethylenebiguanide hydrochlorides, benzalkonium chlorides, polyamino propylbiguanides, and 1-2-benzisothiazoline-3-ones. For specific example, an aqueous pesticidal spray mixture may comprise Proxel® GXL (Arch Chemicals Inc., Atlanta, Ga.) as a biocide.

Suitable active ingredients for use in the aqueous pesticidal spray mixtures described herein include herbicides such as, for example, auxinic herbicides (such as 2,4-D, 2,4-DB, aminopyralid, clopyralid, dicamba, fluroxypyr, halauxifen, halauxifen-methyl, MCPA, MCPB, picloram or triclopyr), acetochlor, atrazine, benfluralin, clethodim, cloransulam, cyhalofop, diclosulam, dithiopyr, ethalfluralin, florasulam, flumetsulam, glufosinate, glyphosate, haloxyfop, isoxaben, MSMA, oryzalin, oxyfluorfen, pendimethalin, penoxsulam, propanil, pyroxsulam, quizalofop, sethoxydim, tebuthiuron, and trifluralin, Suitable active ingredients for use in the described compositions also include herbicide safeners such as, for example, cloquintocet, flurazole, mefenpyr, and TI-35. Suitable active ingredients for use in the described compositions also include insecticides such as, for example, chlorpyrifos, chlorpyrifos-methyl, gamma-cyhalothrin, cypermethrin, deltamethrin, halofenozide, methoxyfenozide, sulfoxaflor, spinosad, spinetoram, and tebufenozide. Suitable active ingredients for use in the described compositions also include fungicides such as, for example, fenbuconazole, mancozeb, myclobutanil, propiconazole, quinoxyfen, thifluzamide, and zoxamide.

When the aqueous pesticidal spray mixtures described herein contain water soluble salts of auxinic herbicides and/or the water soluble salt of glyphosate, suitable cations contained in these salts include isopropyl ammonium, dimethyl ammonium, triethyl ammonium, monoethanol ammonium, diethanol ammonium, triethanol ammonium, dimethylethanol ammonium, diethyleneglycol ammonium, triisopropanol ammonium, tetramethyl ammonium, tetraethyl ammonium, choline, potassium, and cations derived from bis(aminopropyl)methylamine. For example, useful 2,4-D salts include the 2,4-D choline salt and the 2,4-D dimethyl ammonium salt, and useful glyphosate salts include the glyphosate dimethyl ammonium salt, the glyphosate isopropyl ammonium salt, and the glyphosate potassium salt.

In an example of an aqueous pesticidal spray mixture, the auxinic herbicide is 2,4-D choline salt or 2,4-D dimethyl ammonium salt and the glyphosate is glyphosate dimethyl ammonium salt, glyphosate isopropyl ammonium salt, or glyphosate potassium salt. In another example of an aqueous pesticidal spray mixture, the auxinic herbicide is 2,4-D choline salt or 2,4-D dimethyl ammonium salt, the glyphosate is glyphosate dimethyl ammonium salt, glyphosate isopropyl ammonium salt, or glyphosate potassium salt, and the organic colloid is an anionic carnauba wax dispersion, a nonionic polyethylene dispersion, or a nonionic ethylene acrylic acid copolymer dispersion. In a further example of an aqueous pesticidal spray mixture, the auxinic herbicide is 2,4-D choline salt, the glyphosate is glyphosate dimethyl ammonium salt, and the organic colloid is a nonionic polyethylene dispersion.

The optimum spray droplet size depends on the application for which the pesticidal composition is used. If droplets are too large, there will be less coverage by the spray; i.e, large droplets will land in certain areas while areas in between will receive little or no spray coverage. The maximum acceptable droplet size may depend on the amount of composition being applied per unit area and the need for uniformity in spray coverage. Smaller droplets provide more even coverage, but are more prone to drift during spraying. Thus, application parameters such as uniformity in spray coverage must be balanced against the tendency for smaller droplets to drift. For example, if it is particularly windy during spraying, larger droplets may be needed to reduce drift, whereas on a calmer day smaller droplets may be acceptable.

In addition to the physical properties of a particular aqueous pesticidal composition, spray droplet size may also depend on the spray apparatus, e.g., nozzle size and configuration. The reduction in spray drift may result from a variety of factors including a reduction in the production of fine spray droplets (<150 μm minimum diameter) and an increase in the volume median diameter (VMD) of the spray droplets. In any event, for a given spray apparatus, application, and conditions, and based on the organic colloid-stabilized oil-in-water emulsion used, the median diameter of the plurality of spray droplets created using the compositions and methods described herein is increased above that of a spray composition that does not include the organic colloid-stabilized oil-in-water emulsion as described herein.

In addition to the methods described above, aqueous concentrate compositions are also described. As used herein aqueous concentrate compositions are solutions containing high concentrations of an aqueous pesticidal spray component described above, i.e., one or more water soluble auxinic herbicide salts and an organic colloid-stabilized oil-in-water emulsion. The aqueous concentrate compositions are intended to be diluted to provide aqueous pesticidal spray mixtures for use, for example, with the methods described herein. The aqueous concentrate compositions include from 0.1 to 95 weight percent of one or more water soluble salts of an auxinic herbicide and from 0.01 to 20 weight percent of an organic colloid-stabilized oil-in-water emulsion. The aqueous concentrate compositions can additionally include glyphosate. In aqueous concentrate compositions as described herein that additionally include glyphosate, the aqueous concentrate compositions contain about 10 to about 45 weight percent of the water soluble glyphosate salt; about 10 to about 45 weight percent of the one or more water soluble auxinic herbicide salts; and 0.1 to 18 weight percent of the organic colloid-stabilized oil-in-water emulsion, 0.1 to 16 weight percent of the organic colloid-stabilized oil-in-water emulsion, 0.1 to 14 weight percent of the organic colloid-stabilized oil-in-water emulsion, 0.1 to 12 weight percent of the organic colloid-stabilized oil-in-water emulsion, 0.1 to 10 weight percent of the organic colloid-stabilized oil-in-water emulsion, 0.1 to 9 weight percent of the organic colloid-stabilized oil-in-water emulsion, 0.1 to 8 weight percent of the organic colloid-stabilized oil-in-water emulsion, 0.1 to 7 weight percent of the organic colloid-stabilized oil-in-water emulsion, 0.1 to 6 weight percent of the percent of the organic colloid-stabilized oil-in-water emulsion, 0.1 to 5 weight percent of the organic colloid-stabilized oil-in-water emulsion, 0.1 to 4.5 weight percent of the organic colloid-stabilized oil-in-water emulsion, 0.1 to 4 weight percent of the organic colloid-stabilized oil-in-water emulsion, 0.1 to 3.5 weight percent of the organic colloid-stabilized oil-in-water emulsion, 0.1 to 3 weight percent of the organic colloid-stabilized oil-in-water emulsion, 0.1 to 2.5 weight percent of the organic colloid-stabilized oil-in-water emulsion, 0.1 to 2 weight percent of the organic colloid-stabilized oil-in-water emulsion, 0.1 to 1.5 weight percent of the organic colloid-stabilized oil-in-water emulsion, or 0.1 to 1 weight percent of the organic colloid-stabilized oil-in-water emulsion. The aqueous concentrate compositions can be stored in suitable containers as will be readily recognized by one of skill in the art and can be, for example, solutions, emulsions, or suspensions.

In an example of an aqueous concentrate composition, the auxinic herbicide is 2,4-D choline salt or 2,4-D dimethyl ammonium salt and the glyphosate is glyphosate dimethyl ammonium salt, or glyphosate isopropyl ammonium salt. In another example of an aqueous concentrate composition, the auxinic herbicide is 2,4-D choline salt or 2,4-D dimethyl ammonium salt, the glyphosate is glyphosate dimethyl ammonium salt, or glyphosate isopropyl ammonium salt, and the organic colloid is an anionic carnauba wax dispersion, a nonionic polyethylene dispersion, or a nonionic ethylene acrylic acid copolymer dispersion. In a further example of an aqueous concentrate composition, the auxinic herbicide is 2,4-D choline salt, the glyphosate is glyphosate dimethyl ammonium salt, and the organic colloid is a nonionic polyethylene dispersion.

Aqueous solutions, i.e., including both concentrates and spray solutions, containing 2,4-D and glyphosate are prone to incompatibility under certain conditions and concentrations leading to product performance issues and difficulty in using the products, i.e., difficulty with field applications of the products. Incompatibility in concentrate compositions is minimized by the use of very small amounts of 2,4-D, such as less than about 3 wt % ae (acid equivalent) relative to the total composition. High-strength aqueous compositions of certain organo ammonium salts of 2,4-D and glyphosate where the weight ratio (ae basis) of the 2,4-D salt to the glyphosate salt is from about 2.3:1 to about 1:2.3 and the compositions may contain up to or greater than 450 g ae/L of total active ingredients are described in U.S. application Ser. No. 12/763,566, which is incorporated herein by reference. These compositions are generally homogeneous and free-flowing at temperatures ranging from 54° C. to about −10° C.

Optionally, the compositions described herein may additionally contain surfactants. For example, compositions as described that include glyphosate can optionally include an efficacy enhancing surfactant. The surfactants may be anionic, cationic, or nonionic in character. Examples of typical surfactants include alcohol-alkylene oxide addition products, such as tridecyl alcohol-C₁₆ ethoxylate; sorbitol esters, such as sorbitol oleate; quaternary amines, such as lauryl trimethylammonium chloride; ethoxylated amines, such as tallowamine ethoxylated; betaine surfactants, such as cocoamidopropyl betaine; fatty acid amidopropyl dimethylamine surfactants such as cocoamidopropyl dimethylamine;

alkylpolyglycoside surfactants; polyethylene glycol esters of fatty acids, such as polyethylene glycol stearate; block copolymers of ethylene oxide and propylene oxide; salts of mono and dialkyl phosphate esters; and mixtures thereof. The additional surfactant or mixture of surfactants is usually present at a concentration of from about 0.5 to about 20 weight percent of the formulation.

Additionally, compositions optionally containing one or more additional compatible ingredients are provided herein. These additional ingredients may include, for example, one or more pesticides or other ingredients, which may be dissolved or dispersed in the composition and may be selected from acaricides, bactericides, fungicides, insecticides, herbicides, herbicide safeners, insect attractants, insect repellents, plant activators, plant growth regulators, and synergists. Also, any other additional ingredients providing functional utility such as, for example, dyes, stabilizers, fragrants, viscosity-lowering additives, compatibility agents, and freeze-point depressants may be included in these compositions.

The following Examples are presented to illustrate various aspects of the compositions and methods described herein and should not be construed as limitations to the claims.

### EXAMPLE 1

### Organic Colloid-Stabilized Oil-in-Water Emulsion Concentrates

Organic colloid-stabilized oil-in-water emulsion concentrates containing 5 wt % of paraffin oil, 2.5 wt % of an organic colloid, and 92.5 wt % of water were prepared. A 4-ounce (oz) (118 mL) vial was first charged with 5 g of paraffin oil (Sigma-Aldrich; St.Louis, Mo.) and then 2.5 g of an organic colloid (dry basis) was added as a dispersion in water. The remaining water was added to provide 100 g of a mixture containing the paraffin oil, the organic colloid and water. The mixture was then homogenized using a Vibra-Cell™ ultrasonic processor (Sonics & Materials, Inc.; Newtown, Conn.) to provide a milky-white emulsion concentrate. Table 1 lists the Michem® Emulsion samples used in the compositions and methods described herein.

TABLE 1
Organic Colloid Samples Used to Prepare
Stabilized Oil-in-water Emulsions

| Organic | Organic Colloid Description | Particle |
|---|---|---|
| colloid¹ | (all supplied in water) | size (nm) |
| ME70350 | 50% Cationic paraffin wax dispersion | 500 |
| ME62125 | 25% Anionic carnauba wax dispersion | 90 |
| ME34935 | 35% Anionic paraffin/ethylene acrylic | 275 |
| | acid copolymer dispersion | |
| ME29730 | 30% Nonionic polyethylene dispersion | 45 |
| ME80939M | 40% Nonionic paraffin wax dispersion | 1000 |
| ME44730 | 30% Nonionic ethylene acrylic acid | 50 |
| | copolymer dispersion | |
| ME09625 | 25% Cationic ethylene acrylic acid | 50 |
| | copolymer dispersion | |

¹Michem ® Emulsion samples were purchased from Michelman (Cincinnati, OH) and were used as received.

### Organic Colloid Stabilized Oil-in-Water Emulsions—Spray Samples and Spray Droplet Analysis:

Each of the organic colloid-stabilized emulsion concentrates was diluted in water to make a 5% v/v spray solution by diluting 15 mL of the emulsion concentrate with 285 mL of deionized water and then slightly shaking by hand until each spray sample was homogenous. The seven spray solutions (and one water control sample) were sprayed using a Teejet® 8002 flat fan nozzle (Teejet Technologies; Wheaton, Ill.) at 40 psi (276 kiloPascal) and the spray droplet size distribution measurement was performed with a Sympatec Helos/KF high resolution laser diffraction particle sizer with an R7 lens (Sympatec GmbH; Clausthal-Zellerfeld, Germany). The tip of the nozzle was situated 12 inches (30.5 centimeters) above the path of the laser beam of the Sympatec particle sizer. The percentage of driftable fines was expressed as the volume percentage of spray droplets below 150 μm volume mean diameter (VMD) as shown in Table 2.

TABLE 2
Spray Droplet Analysis of Sprays Containing Organic
Colloid-stabilized Oil-in-water Emulsions

| | | Volume |
|---|---|---|
| | Spray | Percentage of |
| Organic Colloid Used | Droplet | Driftable Fines <150 |
| (see Table 1) | VMD, μm | μm VMD |
| None (control) - deionized water | 164 | 44% |
| Cationic paraffin wax dispersion | 209 | 31% |
| Anionic carnauba wax dispersion | 272 | 17% |
| Anionic paraffin/ethylene acrylic | 235 | 25% |
| acid copolymer dispersion | | |
| Nonionic polyethylene dispersion | 280 | 15% |
| Nonionic paraffin wax dispersion | 201 | 33% |
| Nonionic ethylene acrylic acid | 280 | 15% |
| copolymer dispersion | | |
| Cationic ethylene acrylic acid | 253 | 21% |
| copolymer dispersion | | |

### EXAMPLE 2

### Herbicide Concentrates Containing Organic Colloid-Stabilized Emulsions

Herbicide concentrates containing 456 grams acid equivalent per liter (g ae/L) 2,4-D choline, 50 grams per kilogram (g/kg) propylene glycol, and 50 g/kg of one of the organic colloid-stabilized emulsion concentrates described herein were prepared as follows. A 4-oz vial was first charged with 86.00 g of a 44.5 wt % ae 2,4-D choline salt solution in water. To the vial, 5.00 g of propylene glycol was added and the liquids were then blended by hand shaking the flask until a homogenous solution was obtained. Then, 5.00 g of an organic colloid-stabilized emulsion concentrate (containing 30 wt % paraffin oil, 14 wt % of an organic colloid, and 56 wt % of water) was added to the vial. The vial was once again hand shaken until the contents were blended and homogenous. Lastly, 4.00 g of deionized water was added to the vial to provide 100 g of the herbicide concentrate containing the organic colloid-stabilized, oil-in-water emulsion. Three samples each containing one of the organic colloids listed in Table 1 and one sample containing no organic colloid-stabilized emulsion were prepared in this manner.

### Herbicide Spray Samples and Spray Droplet Analysis:

Each of the herbicide concentrates were then diluted in water to make a 1.87% v/v spray solution of each by taking 5.61 mL of the herbicide concentrate and placing it into 294.39 mL of deionized water and then lightly shaking by hand until each spray sample was homogenous. The four samples were sprayed using the equipment and procedure described in Example 1. The percentage of driftable fines was expressed as the volume percentage of spray droplets below 150 μm volume mean diameter (VMD) as shown in Table 3.

TABLE 3
Spray Droplet Analysis of Herbicide Sprays Containing 2,4-D
Choline and Organic Colloid-stabilized Oil-in-water Emulsions

| | Spray | Volume Percent |
|---|---|---|
| Organic Colloid Used | Droplet | Driftable Fines <150 |
| (Table 1) | VMD, μm | μm VMD |
| none (control) | 163 | 45% |
| Nonionic polyethylene dispersion | 237 | 25% |
| Anionic carnauba wax dispersion | 225 | 28% |
| Nonionic ethylene acrylic acid | 198 | 35% |
| copolymer dispersion | | |

### EXAMPLE 3

### Organic Colloid-Stabilized Oil-in-Water Emulsion Concentrates Prepared with Styrene-Butadiene Latex

Emulsion A. The following were combined in order: 20 g of deionized water, 10 g of DL 620 styrene-butadiene latex (50 wt % in water; available from Dow Chemical), and 10 g of Agnique® ME1218 (Cognis-BASF; Cincinnati, Ohio). After brief, mild agitation a latex-stabilized methyl soyate emulsion was obtained.

Emulsion B. The following were combined in order: 20 g of deionized water, 10 g of UCAR® 162 vinyl acrylic latex (55 wt % in water; available from Dow Chemical), and 10 g of Agnique® ME1218 (Cognis-BASF; Cincinnati, Ohio). After brief, mild agitation a latex-stabilized methyl soyate emulsion was obtained.

### Emulsion and Herbicide Spray Samples, and Spray Droplet Analysis:

Spray dilutions of Emulsions A and B were prepared by adding 1 wt % of each emulsion to deionized water or to a 2.26 wt % aqueous solution of Round-up PowerMax®

(Monsanto; St.Louis, Mo.). The four spray solutions and two control solutions were sprayed using the equipment and procedure described in Example 1. The percentage of driftable fines was expressed as the volume percentage of spray droplets below 150 μm volume mean diameter (VMD) as shown in Table 4.

TABLE 4
Spray Droplet Analysis of Sprays Containing Organic
Colloid-stabilized Oil-in-water Emulsions Containing
Styrene-butadiene or Vinyl-acrylic Latex

| | Volume Percent |
|---|---|
| Spray Samples w/or w/o Latex | Driftable Fines <150 |
| Stabilized Emulsions | μm VMD |
| Deionized water (control) | 44.1 |
| Emulsion A + deionized water | 24.0 |
| Emulsion B + deionized water | 17.1 |
| Roundup PowerMax ® (control) | 51.1 |
| Emulsion A + Roundup PowerMax ® | 18.8 |
| Emulsion B + Roundup PowerMax ® | 19.3 |

The present invention is not limited in scope by the embodiments disclosed herein which are intended as illustrations of a few aspects of the invention and any embodiments which are functionally equivalent are within the scope of this invention. Various modifications of the compositions and methods in addition to those shown and described herein will become apparent to those skilled in the art and are intended to fall within the scope of the appended claims. Further, while only certain representative combinations of the composition components and method steps disclosed herein are specifically discussed in the embodiments above, other combinations of the composition components and method steps will become apparent to those skilled in the art and also are intended to fall within the scope of the appended claims. Thus a combination of components or method steps may be explicitly mentioned herein; however, other combinations of components and method steps are included, even though not explicitly stated. The term comprising and variations thereof as used herein is used synonymously with the term including and variations thereof and are open, non-limiting terms.

What is claimed is:

1. A method to reduce spray drift during the application of an aqueous pesticidal spray mixture comprising incorporating into the aqueous pesticidal spray mixture from 0.01 to 10 weight percent of an organic colloid-stabilized oil-in-water emulsion.

2. The method of claim 1, wherein the pesticidal spray mixture comprises at least one of a herbicide, an insecticide, and a fungicide.

3. The method of claim 1, wherein the organic colloid-stabilized oil-in-water emulsion comprises a water-insoluble oil, an organic colloid, and water.

4. The method of claim 1, wherein the organic colloid is a cationic organic colloid or anionic organic colloid.

5. The method of claim 1, wherein the organic colloid is a polymer dispersion, a copolymer dispersion, a wax dispersion or a latex.

6. The method of claim 1, wherein the organic colloid is a polyethylene dispersion, a polyacrylate latex, a polystyrene latex, a polystyrene-butadiene latex, or mixtures thereof.

7. The method of claim 1, wherein the organic colloid is an anionic carnauba wax dispersion, a nonionic polyethylene dispersion, a nonionic ethylene-acrylic acid copolymer dispersion, or mixtures thereof.

8. The method of claim 3, wherein the water-insoluble oil is selected from a paraffin oil, an aliphatic oil, an aromatic oil, a vegetable oil, a seed oil, an animal oil, an alkylated vegetable, seed or animal oil, or mixtures thereof.

9. The method of claim 2, wherein the herbicide is an auxinic herbicide.

10. The method of claim 9, wherein the auxinic herbicide is a water soluble salt of 2,4-D, a water soluble salt of triclopyr, a water soluble salt of dicamba, or mixtures thereof.

11. The method of claim 9, wherein the auxinic herbicide is a water soluble salt of 2,4-D.

12. The method of claim 9, wherein the auxinic herbicide is 2,4-D choline salt.

13. The method of claim 9, wherein the auxinic herbicide is 2,4-D dimethyl ammonium salt.

14. The method of claim 9, wherein the pesticidal spray mixture further comprises glyphosate.

15. The method of claim 14, wherein the glyphos ate is glyphos ate dimethyl ammonium salt, glyphosate isopropyl ammonium salt, or glyphosate potassium salt.

16. The method of claim 14, wherein the auxinic herbicide is 2,4-D choline salt or 2,4-D dimethyl ammonium salt and the glyphosate is glyphosate dimethyl ammonium salt, glyphosate isopropyl ammonium salt, or glyphosate potassium salt.

17. The method of claim 14, wherein the auxinic herbicide is 2,4-D choline salt or 2,4-D dimethyl ammonium salt, the glyphosate is glyphosate dimethyl ammonium salt, glyphosate isopropyl ammonium salt or glyphosate potassium salt, and the organic colloid is an anionic carnauba wax dispersion, a nonionic polyethylene dispersion, or a nonionic ethylene-acrylic acid copolymer dispersion.

18. The method of claim 14, wherein the auxinic herbicide is 2,4-D choline salt, the glyphosate is glyphosate dimethyl ammonium salt, and the organic colloid is a nonionic polyethylene dispersion.

19. The method of claim 14, wherein the auxinic herbicide is a water soluble salt of 2,4-D and the acid equivalent (AE) weight ratio of the water soluble 2,4-D salt to the glyphosate salt is from 2.3:1 to 1:2.3.

20. An aqueous concentrate composition comprising from 0.1 to 95 weight percent of at least one pesticide and from 0.01 to 20 weight percent of an organic colloid-stabilized oil-in-water emulsion.

21. The aqueous concentrate composition of claim 20, wherein the organic colloid-stabilized oil-in-water emulsion comprises an oil, an organic colloid, and water.

22. The aqueous concentrate composition of claim 21, wherein the organic colloid is a cationic organic colloid or anionic organic colloid.

23. The aqueous concentrate composition of claim 21, wherein the organic colloid is a polyethylene dispersion, a polyacrylate latex, a polystyrene latex, a polystyrene-butadiene latex, or mixtures thereof.

24. The aqueous concentrate composition of claim 21, wherein the organic colloid is an anionic carnauba wax dispersion, a nonionic polyethylene dispersion, a nonionic ethylene-acrylic acid copolymer latex, or mixtures thereof.

25. The aqueous concentrate composition of claim 21, wherein the oil is selected from a paraffinic oil, an aliphatic oil, an aromatic hydrocarbon oil, a vegetable oil, a seed oil, an animal oil, an alkylated vegetable, seed, or animal oil, or mixtures thereof.

26. The aqueous concentrate suspension of claim 20, wherein the pesticide is an auxinic herbicide.

27. The aqueous concentrate composition of claim 26, wherein the auxinic herbicide is a water soluble salt of 2,4-D.

28. The aqueous concentrate composition of claim 26, wherein the auxinic herbicide is 2,4-D choline salt.

29. The aqueous concentrate composition of claim 26, wherein the auxinic herbicide is 2,4-D dimethyl ammonium salt.

30. The aqueous concentrate composition of claim 26, further comprising glyphosate and optionally, an efficacy enhancing surfactant.

31. The aqueous concentrate composition of claim 30, wherein the glyphosate is glyphosate dimethyl ammonium salt or glyphosate isopropyl ammonium salt.

32. The aqueous concentrate composition of claim 30, wherein the auxinic herbicide is 2,4-D choline salt or 2,4-D dimethyl ammonium salt and the glyphosate is glyphosate dimethyl ammonium salt, or glyphosate isopropyl ammonium.

33. The aqueous concentrate composition of claim 30, wherein the auxinic herbicide is 2,4-D choline salt or 2,4-D dimethyl ammonium salt, the glyphosate is glyphosate dimethyl ammonium salt, or glyphosate isopropyl ammonium salt, and the organic colloid is an anionic carnauba wax dispersion, a nonionic polyethylene dispersion, or a nonionic ethylene-acrylic acid copolymer latex.

34. The aqueous concentrate composition of claims 30, wherein the auxinic herbicide is 2,4-D choline salt, the glyphosate is glyphosate dimethyl ammonium salt, and the organic colloid is a nonionic polyethylene dispersion.

35. The aqueous concentrate composition of claim 30, wherein the auxinic herbicide is a water soluble salt of 2,4-D and the AE weight ratio of the water soluble 2,4-D salt to the glyphosate salt is from 2.3:1 to 1:2.3.

36. An aqueous concentrate composition for use as a pesticide tank-mix additive to reduce spray drift during pesticide spray applications comprising from 0.01 to 50 weight percent of an organic colloid-stabilized oil-in-water emulsion.

37. A method of preparing a spray tank mixture for use in applying a pesticidal spray with reduced spray drift comprising mixing together spray water, a pesticide concentrate or pre-mix, and an organic colloid-stabilized oil-in-water emulsion.
